(19) United States
(12) Patent Application Publication
(10) Pub. No.: US 2002/0027776 A1
(43) Pub. Date: Mar. 7, 2002

(54) Car locator

(76) Inventor: Leon S. Gross, Philadelphia, PA (US)

Correspondence Address: DONALD R. PIPER, JR., Dann, Dorfman, Herrell & Skillman, P.C., Suite 720, 1601 Market Street, Philadelphia, PA, 19103-2307, US

(21) Appl. No.: 09/880,997

(22) Filed: Oct. 19, 2001

Related U.S. Application Data
(63) Continuation-in-part of application No. 09/594,381, filed on Jun. 15, 2000.

(51) Int. Cl. F21V 9/16

(52) U.S. Cl. 362/84

(57) ABSTRACT

A car locator is provided having a case for placing on a car dashboard, having openings through which electroluminescent tape mounted to a circuit board within the case are exposed such that, when illuminated, a person will be able to quickly locate his or her car in a crowded parking lot. The car locator may be powered by a portable battery or connected to the car battery via the cigarette lighter. The car locator has a switch which allows a user to illuminate the electroluminescent tape in a variety of ways.

### RELATED APPLICATIONS

This application is a continuation-in-part of U.S. application Ser. No. 09/594,381, filed on Jun. 15, 2000 which is incorporated herein by reference.

### FIELD OF THE INVENTION

The present invention generally relates to a car locator and, more specifically, to a highly visible, car locator that is placed on the dashboard of a car in a conspicuous position to assist a user in locating his or her car in a parking area.

### BACKGROUND OF THE INVENTION

Various types of markers have been used over the years to help people locate their vehicles in a variety of parking areas. Typically, a car marker, such as a ribbon or a ball, is attached to a radio antenna or in some other conspicuous location on a car to provide enhanced visibility of the car in parking areas.

One of the problems frequently encountered in utilizing conventional marking devices has been the difficulty of securing such devices to a car to prevent inadvertent detachment while at the same time enabling the devices to be conveniently reoriented or removed if necessary. In many instances, for example, tools may be required to affix or remove the devices. While not an overwhelming problem, the need for tools becomes most inconvenient if the marking device must be removed at remote locations. For example, the need for tools becomes a particular nuisance if the car marker must be temporarily removed at a location such as an automatic car wash.

In other instances, suction cup mounting has been employed to eliminate the need for tools. However, the use of suction cups is not always satisfactory because suction cups require a suitable mounting surface—one that is dry, clean and relatively flat, to permit secure attachment. The tendency of suction cups to prematurely release due to temperature or pressure changes is also a problem. As a result, the marking device might be damaged or lost in the event that a user neglects to remove the device prior to driving the car.

Other conventional devices suffer from the drawback that, once mounted, such devices cannot be easily repositioned into less conspicuous orientations. Another major disadvantage of conventional car markers is that they are difficult to see at night or in dark parking areas. Although many are brightly colored, they are still hard to discern under poor lighting conditions.

### SUMMARY OF THE INVENTION

In accordance with the present invention, a car locator is provided. More specifically, a car locator having an electroluminescent material is provided thereby facilitating car location at night or in dimly lit areas. The car locator may be placed on the dashboard for the light to shine through the dashboard. A driver looking for his or her car in the darkness of night is attracted to the location of the car due to the light shining through the car windshield. Furthermore, since the device is locatable inside the car and most conveniently on the car dashboard, it cannot be misplaced or removed by anyone but the driver.

The visibility of the car locator is enhanced by illumination of a selected lighting source such as an electroluminescent material. The car locator may include a base such as a rectangular box having openings in the form of a pattern of apertures for exposing an electroluminescent material. The box can be removably positioned on the dash or some other selected location to facilitate viewing. Different colors of electroluminescent material may be used in association with different patterns of apertures so that selected patterns of apertures may be illuminated in different selected colors to provide an easily recognizable pattern of light for the user. A control circuit is provided including a selected power source for enabling the illumination of the electroluminescent material. A selector is provided for the power control, such as a manual selector switch, to enable selected illumination of the electroluminescent material. The selector switch may, for example, be in the form of one or more push buttons for lighting different patterns or colors or in the form of rotatable thumb switch for rotation into different positions for lighting different patterns or colors of light.

The power source may be in the form of a battery housed within a base. Alternatively, the power source may be mounted directly to the base. In yet another embodiment, the power source may be the car battery accessible by an adapter that plugs into the cigarette lighter. A switch may be included as part of the selector for the purpose of turning the device “on” when the locator is in use and “off” when the locator is not being used. In another embodiment, a photosensor turn the light on or off in response to the ambient light level sensed by the photosensor.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a schematic perspective view of the car locator of the present invention having a pattern of apertures to expose electroluminescent material for lighting the car locator;

FIG. 2 is a schematic front elevational view of the car locator shown in FIG. 1;

FIG. 3 is a schematic rear internal view of the car locator shown in FIG. 2;

FIG. 4 is a schematic rear elevational view of the car locator shown in FIG. 1;

FIG. 5 is a rear elevational view of a circuit board for the car locator shown in FIG. 1;

FIG. 6 is a schematic circuit diagram of an optional photosensor circuit for activating the car locator of FIG. 1;

FIG. 7 is a perspective view of an alternate embodiment of the car locator of the present invention having a pattern of apertures to expose electroluminescent material for lighting the car locator;

FIG. 8 is a schematic front elevational view of the car locator shown in FIG. 7;

FIG. 9 is a schematic rear internal view of the car locator shown in FIG. 8;

FIG. 10 is a schematic rear elevational view of the car locator shown in FIG. 7; and

FIG. 11 is a rear elevational view of a circuit board for the car locator shown in FIG. 7.

### DETAILED DESCRIPTION OF THE PREFERRED EMBODIMENTS

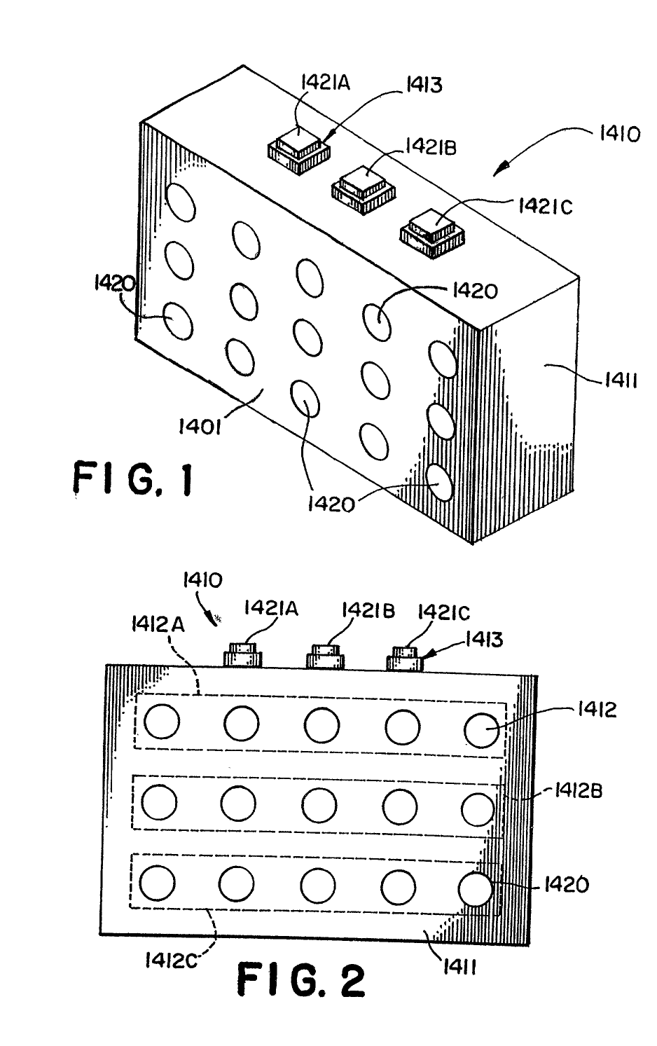

Referring now to FIGS. 1-5, a car locator 1410 in accordance with the present invention is depicted. The locator 1410 comprises a generally box shaped case 1411. The case 1411 is preferably molded from a high impact plastic, but may be formed of other suitable materials. The car locator 1410 may be placed on the dashboard or other suitable interior location of a car or other vehicle. The car locator 1410 is then illuminated in order to help a user locate the vehicle in a darkened parking lot.

Formed into the front face 1401 of the case 1411 are a plurality of openings 1420 through which an underlying electroluminescent material 1412 may be exposed. The electroluminescent material 1412 may be secured to a circuit board 1440 in proper positions to align with the openings 1420. Three rows of five circular openings are employed on the front face 1401 of the car locator. However, a greater or lesser number of rows and columns of openings may be used. Other configurations and shapes of openings may also be used. Also mounted on case 1411 are actuation switches 1413 for illuminating the electroluminescent material 1412. Switches 1413 may be comprised of push buttons 1421A, B, and C, which when depressed, alternately close the electric circuit between contacts 1415 and 1416 to illuminate the electroluminescent material 1412 or open the electric circuit to turn off the electroluminescent material 1412. As shown in FIGS. 2 and 3, one switch 1421A activates a top electroluminescent tape strip 1412A, a middle switch 1421B activates a middle electroluminescent tape strip 1412B and a third switch 1421C activates a bottom electroluminescent tape strip 1412C. Each of the electroluminescent tape strips 1412A, B, and C, may include a different color to effect a selected color pattern of illumination. The electroluminescent tape 1412 may be a single color or several different colors. For instance, in one embodiment, the top row might be red, the middle row yellow, and the bottom row white. The plurality of switches 1421A, B, and C, such as shown in FIGS. 1-4, are actuatable to illuminate the different colors or patterns of electroluminescent tape. Alternatively, in the multiple switch embodiment of the present invention, one switch may be used to control the intensity of the electroluminescent tape 1412. For example, switch 1412A might be used to turn all three rows on at a lowest intensity, while the other switches 1412B and C might be used to increase the intensity to a middle and highest intensity, respectively.

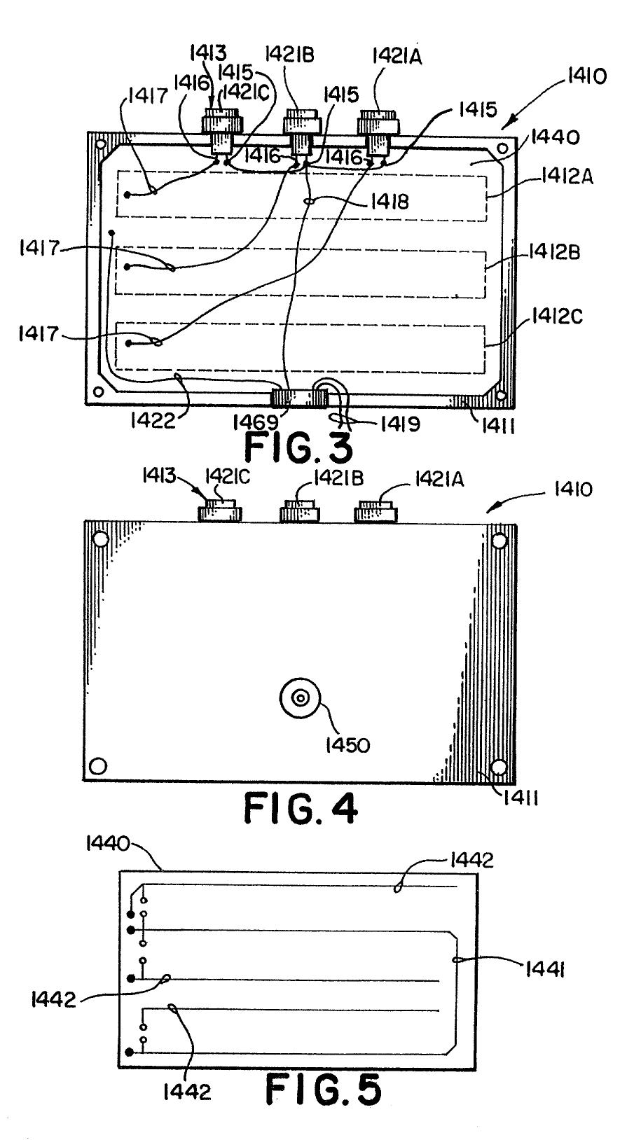

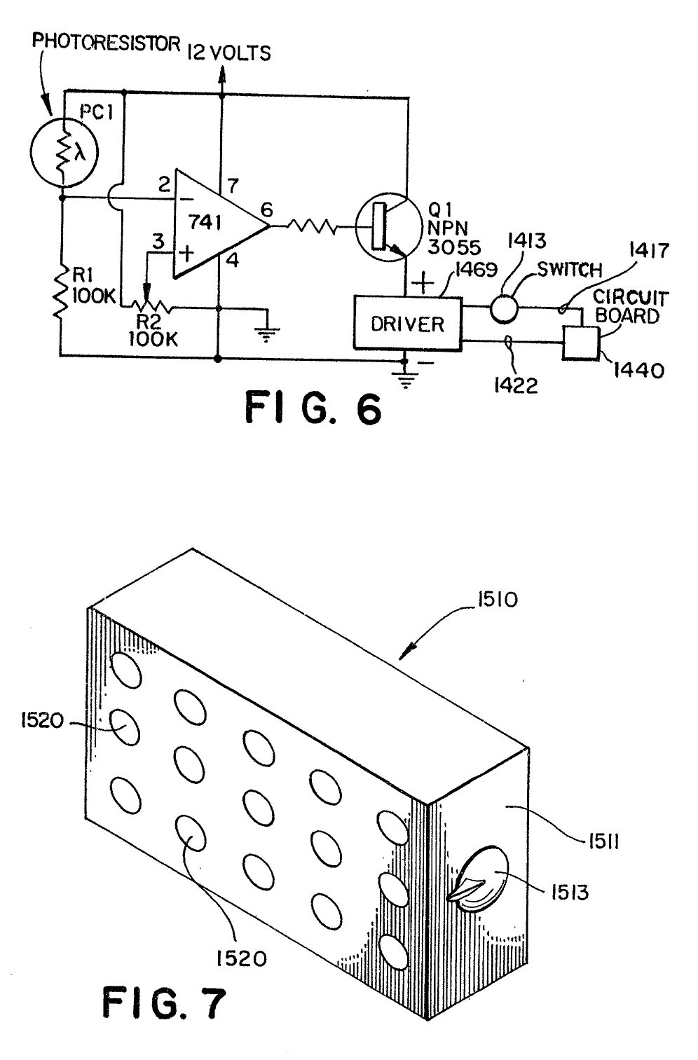

Case 1411 houses a driver 1469 which converts DC power from a car or portable battery into appropriate AC power to light the electroluminescent tape. One contact 1415 of each switch 1412A, B, and C is electrically connected to the driver 1469 via a lead 1418, while the other contact 1416 of each switch is electrically connected to a corresponding run 1442 on circuit board 1440 as shown in FIG. 5 via a lead 1417. Referring to FIG. 4, an external connector 1450 is mounted on the back of case 1411 to connect the locator 1410 to an external power source such as a car battery or other selected external power source. External connector 1450 is electrically connected to the driver 1469 via leads 1419. The driver 1469 may include additional circuit components such as those shown in FIG. 6, for operation with a photosensor PC1 which can optionally be used in parallel or series combination with manual switches 1421A, B, and C.

Referring to FIG. 6, an op-amp 741 drives transistor Q1, where the output of the op-amp is controlled by the value of the variable resistor R2 and photoresistor PC1. Photoresistor PC1 has a resistance that varies in response to the presence of ambient light. In the presence of light, photoresistor PC1 attains a small value driving the negative input of the op-amp high and thus minimizing the output of the op-amp. In response, the transistor Q1 is non-conducting thereby maintaining the car locator in its off, unlit state. On the other hand, when the light level on photoresistor PC1 falls below a preselected value, the resistance of the photoresistor attains a value large enough to create a voltage drop across PC1 sufficient to minimize the voltage at the negative input to the op-amp. In response, the output of the op-amp becomes sufficiently large to drive transistor Q1 into conduction and, thus, turn on the car locator. The sensitivity of the response to light may be adjusted by variable resistor R2, which sets a voltage at the positive input of the op-amp. Suitable values of resistors, for example, are R=1100KΩ, R2=100KΩ (max) and R3=1KΩ.

The circuit board 1440, as shown in FIG. 5, is mounted inside of case 1411 such that electroluminescent tapes 1412A, B, and C are aligned to be exposed through the openings 1420 of locator 1410 so that the openings become illuminated when the underlying electroluminescent tape is energized. Contained within circuit board 1440 are runs 1441, which are in electrical contact with the driver 1469 via lead 1422, as shown in FIG. 3. The runs 1441 function to complete the circuit from one terminal of the electroluminescent tape 1412 to the driver 1469. Also contained within the circuit board 1440 are the runs 1442 which function to complete the circuit between leads 1417 and a second terminal of the electroluminescent tape 1412.

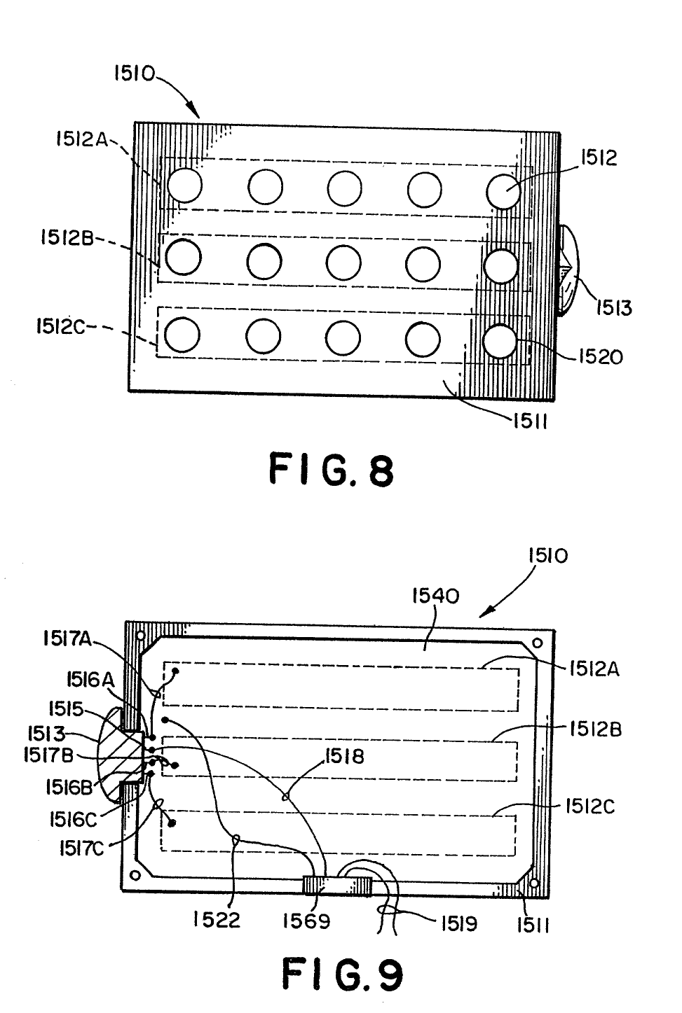

Referring to FIGS. 7-11, another embodiment of the car locator in accordance with the present invention is depicted. The locator 1510 is similar to locator 1410, except that it comprises a rotatable selector switch 1513 instead of push button switches. The rotatable selector switch 1513, when rotated, can be set in one of a plurality of positions. One switch setting could be an “off” position, while other settings could be “on” positions for illuminating the electroluminescent material 1512. For example, as shown in FIGS. 8 and 9, one switch setting may activate a top electroluminescent tape strip 1512A by completing the circuit between contact 1516A and a lead 1518, a second setting activates a middle electroluminescent tape strip 1512B by completing the circuit between contact 1516B and lead 1518, and a third switch setting activates a bottom electroluminescent tape strip 1512C by completing the circuit between contact 1516C and lead 1518. Each of the electroluminescent tape strips 1512A, B, and C, may include a different color to effect a selected color pattern of illumination. The electroluminescent tape 1512 may be a single color or several different colors. For instance, in one embodiment, the top row might be red, the middle row yellow, and the bottom row white. The multi-position thumb turn switch 1513 may then be used to illuminate different colors or patterns of electroluminescent tape. Alternatively, different witch positions may be used to control the intensity of the electroluminescent tape 1512. For example, one switch position might be used to turn all three rows on at a lowest intensity, while other switch positions might be used to increase the intensity to a middle and highest intensity.

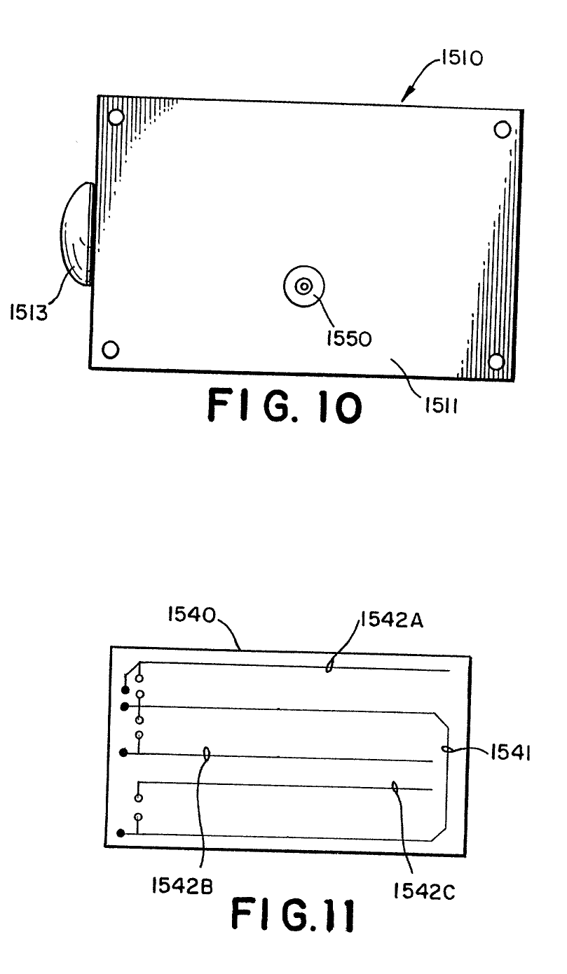

Case 1511 houses a driver 1569, which converts DC power from a car or portable battery into appropriate AC power to light the electroluminescent tape. One contact 1515 of switch 1513 is electrically connected to the driver 1569 via lead 1518, while the other contacts 1516A, B, and C are electrically connected to runs 1542A, B, and C, respectively, on circuit board 1540 as shown in FIG. 5 via leads 1517A, B, and C, respectively. Referring to FIG. 10, an external connector 1550 is mounted on the back of case 1510 to connect the locator 1510 to an external power source such as a car battery or other selected external power source. External connector 1550 is electrically connected to the driver 1569 via leads 1519.

The circuit board 1540, as shown in FIG. 11, is mounted inside of case 1511 so that electroluminescent tapes 1512A, B, and C are aligned to be exposed through the openings 1520 of locator 1510 so that the openings become illuminated when the underlying electroluminescent tape is energized. Contained within circuit board 1540 are runs 1541, which are in electrical contact with the driver 1569 via lead 1522, as shown in FIGS. 9 and 11. The runs 1541 function to complete the circuit from one terminal of the electroluminescent tape 1512 to the driver 1569. Also contained within the circuit board 1540 are the runs 1542A, B, and C which function to complete the circuit between leads 1517A, B, and C, respectively, and a second terminal of the electroluminescent tape 1512. The driver 1569, in a similar fashion as driver 1469, may also include additional circuit components such as those shown in FIG. 6, for operation with an optional photosensor.

It will be recognized by those skilled in the art that changes or modifications may be made to the above-described embodiments without departing from the broad inventive concept of the invention. It should therefore be understood that this invention is not limited to the particular embodiments described herein but is intended to include all changes and modifications that are within the scope and spirit of the invention as set forth in the following claims.

What is claimed is:

1. A vehicle locator for marking a vehicle comprising:
(a) a case;
(b) electroluminescent material within the case;
(c) at least one opening in the case whereby the electroluminescent material is exposed through the opening externally of the case; and
(e) a control circuit in electrical connection with the electroluminescent material for controlling power to the electroluminescent material.

2. The locator according to claim 1 including a power source connected to the control circuit, wherein the power source includes a portable battery.

3. The locator according to claim 1 wherein a plurality of openings are provided in the case for exposing the electroluminescent material.

4. The locator according to claim 3 wherein the plurality of openings are arranged in rows.

5. The locator according to claim 4 wherein a different color of electroluminescent material is positioned beneath each row of openings so that a different color of electroluminescent material may be illuminated in each row.

6. The locator according to claim 1 wherein a plurality of openings are provided in the case for exposing the electroluminescent material and wherein the electroluminescent material includes different colors so that a selected pattern of colors may be exposed through the openings.

7. The locator according to claim 6 comprising a switch electrically connected with the electroluminescent material so that the electroluminescent material may be switched on in a selected pattern of color.

8. The locator according to claim 7 wherein the switch is a rotatable selector switch.

9. The locator according to claim 7 wherein the switch comprises at least one push button switch.

10. The locator according to claim 1 comprising a switch electrically connected with the electroluminescent material so that the electroluminescent material may be switched on in a selected pattern of color.

11. The locator according to claim 9 wherein the switch is a rotatable selector switch.

12. The locator according to claim 10 wherein the switch comprises at least one push button switch.

13. The locator according to claim 7, 8, 9, 10, 11, or 12 comprising a light sensor for actuating the electroluminescent material in response to ambient light.

14. The locator according to claim 13 comprising an adjuster for the light sensor to enable actuation of the electroluminescent material in response to an adjustable level of light.
